(19) United States
(12) Patent Application Publication
(10) Pub. No.: US 2020/0270098 A1
(43) Pub. Date: Aug. 27, 2020

(54) ELEVATOR SAFETY WITH TRANSLATING SAFETY BLOCK

(71) Applicant: Otis Elevator Company, Farmington, CT (US)

(72) Inventors: Tanjil Mustafa, New Britain, CT (US); Yu Pu, Farmington, CT (US)

(21) Appl. No.: 16/287,628

(22) Filed: Feb. 27, 2019

(51) Int. Cl. B66B 5/22; B66B 9/00

(52) U.S. Cl. CPC B66B 5/22; B66B 9/00

(57) ABSTRACT

An elevator system includes a traveling component movable along a guide rail within an elevator hoistway, the traveling component including a structural member; a safety block mounted to the structural member, the safety block translatable in a first direction and a second direction, the safety block including a first brake element and a second brake element; a biasing member configured to position the safety block in a first position corresponding to a first state in which neither the first brake element nor the second brake element is in contact with the guide rail; an actuator configured to translate the safety block in the first direction.

### BACKGROUND

The subject matter disclosed herein generally relates to elevator systems and, more particularly, to safety systems for elevators.

Typical elevator systems use governor overspeed systems coupled to a mechanical safety actuation module in order to activate in the event of a car overspeed event, car overacceleration event, safety chain break, or free fall—i.e., to stop an elevator car that is travelling too fast. Such systems include a linking mechanism to trigger two car safeties simultaneously (i.e., on both guide rails). The governor is located either at the top of the hoistway or may be embedded on the elevator car. The safety actuation module is typically made by a rigid bar or linkage that is located on the car roof or below the car platform—i.e., spanning the width of the elevator car to link opposing sides at the guide rails. However, recent developments have created electrical overspeed safety systems for controlling operation of the elevator car during overspeed, overacceleration, or free fall situations.

### BRIEF SUMMARY

According to embodiment, an elevator system includes a traveling component movable along a guide rail within an elevator hoistway, the traveling component including a structural member; a safety block mounted to the structural member, the safety block translatable in a first direction and a second direction, the safety block including a first brake element and a second brake element; a biasing member configured to position the safety block in a first position corresponding to a first state in which neither the first brake element nor the second brake element is in contact with the guide rail; an actuator configured to translate the safety block in the first direction.

In addition to one or more of the features described above, or as an alternative, further embodiments may include wherein the traveling component is one of an elevator car and a counterweight.

In addition to one or more of the features described above, or as an alternative, further embodiments may include wherein the biasing member comprises a spring.

In addition to one or more of the features described above, or as an alternative, further embodiments may include wherein the biasing member comprises a first spring attached at a first side of the safety block and a second spring attached at a second side of the safety block.

In addition to one or more of the features described above, or as an alternative, further embodiments may include wherein the biasing member comprises a first magnet at a first side of the safety block and a second magnet attached at a second side of the safety block.

In addition to one or more of the features described above, or as an alternative, further embodiments may include wherein the actuator comprises an electromagnet and a permanent magnet.

In addition to one or more of the features described above, or as an alternative, further embodiments may include wherein the electromagnet is mounted to the structural member and the permanent magnet is mounted to the safety block.

In addition to one or more of the features described above, or as an alternative, further embodiments may include wherein the first brake element comprises a stationary brake element.

In addition to one or more of the features described above, or as an alternative, further embodiments may include wherein the second brake element comprises a moving brake element.

In addition to one or more of the features described above, or as an alternative, further embodiments may include wherein the safety block is mounted to the structural member by a mounting plate.

In addition to one or more of the features described above, or as an alternative, further embodiments may include wherein the structural member includes an opening, the mounting plate configured to travel within the opening.

In addition to one or more of the features described above, or as an alternative, further embodiments may include wherein the first direction is perpendicular to a longitudinal axis of the guide rail.

In addition to one or more of the features described above, or as an alternative, further embodiments may include wherein the second direction is perpendicular to the longitudinal axis of the guide rail.

In addition to one or more of the features described above, or as an alternative, further embodiments may include wherein the first direction is opposite the second direction.

In addition to one or more of the features described above, or as an alternative, further embodiments may include wherein the actuator is powered off when the first brake element and the second brake element are not in contact with the guide rail.

In addition to one or more of the features described above, or as an alternative, further embodiments may include wherein the actuator is powered on to bring first brake element and the second brake element into contact with the guide rail.

In addition to one or more of the features described above, or as an alternative, further embodiments may include wherein the actuator is powered on when the first brake element and the second brake element are not in contact with the guide rail.

In addition to one or more of the features described above, or as an alternative, further embodiments may include wherein the actuator is powered of to bring first brake element and the second brake element into contact with the guide rail.

In addition to one or more of the features described above, or as an alternative, further embodiments may include wherein the first brake element is fixed and the second brake element moves.

In addition to one or more of the features described above, or as an alternative, further embodiments may include wherein the first brake element and the second brake element move.

Technical effects of embodiments include providing a safety for a traveling component of an elevator system, such as an elevator car or counterweight, the safety being electrically actuated and having a simple construction.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited by the accompanying figures in which like reference numerals indicate similar elements.

FIG. 1 depicts an elevator system that may employ various embodiments of the present disclosure;

FIG. 2 depicts a prior art arrangement of an overspeed safety system for elevators;

FIG. 3 depicts an elevator car frame having an overspeed safety system in accordance with an embodiment of the present disclosure;

FIG. 4 depicts an elevator safety in a first state in an example embodiment;

FIG. 5 depicts an elevator safety in a second state in an example embodiment;

FIGS. 6-7 depicts an elevator safety transitioning to a third state in an example embodiment;

FIG. 8 depicts a top view of the elevator safety in an example embodiment;

FIG. 9 depicts a rear view of the elevator safety in an example embodiment;

FIG. 10 depicts a mounting plate secured to a safety block in an example embodiment.

### DETAILED DESCRIPTION

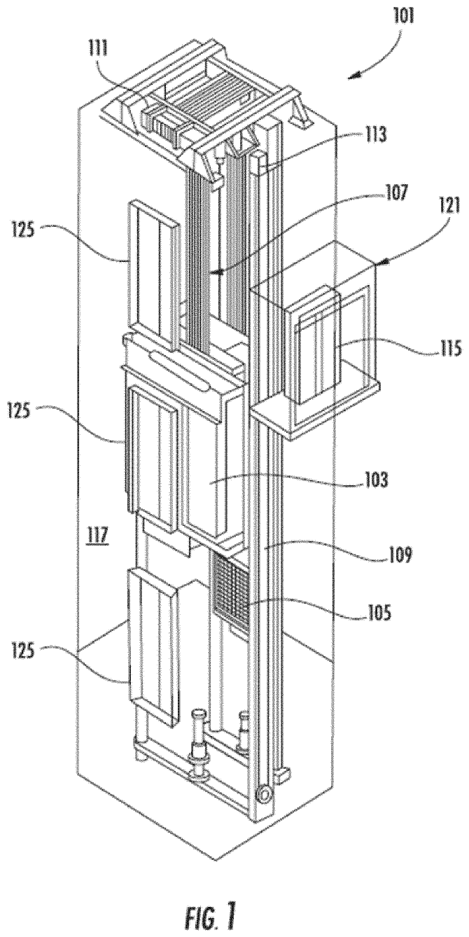

FIG. 1 is a perspective view of an elevator system 101 including an elevator car 103, a counterweight 105, a tension member 107, a guide rail 109, a machine 111, a position reference system 113, and an elevator controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109. As used herein, the term “traveling component” refers to either of the elevator car 103 or the counterweight 105.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter-weight, as known in the art. For example, without limitation, the position reference system 113 can be an encoder, sensor, or other system and can include velocity sensing, absolute position sensing, etc., as will be appreciated by those of skill in the art.

The elevator controller 115 is located, as shown, in a controller room 121 of the elevator shaft 117 and is configured to control the operation of the elevator system 101, and particularly the elevator car 103. For example, the elevator controller 115 may provide drive signals to the machine 111 to control the acceleration, deceleration, leveling, stopping, etc. of the elevator car 103. The elevator controller 115 may also be configured to receive position signals from the position reference system 113 or any other desired position reference device. When moving up or down within the elevator shaft 117 along guide rail 109, the elevator car 103 may stop at one or more landings 125 as controlled by the elevator controller 115. Although shown in a controller room 121, those of skill in the art will appreciate that the elevator controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

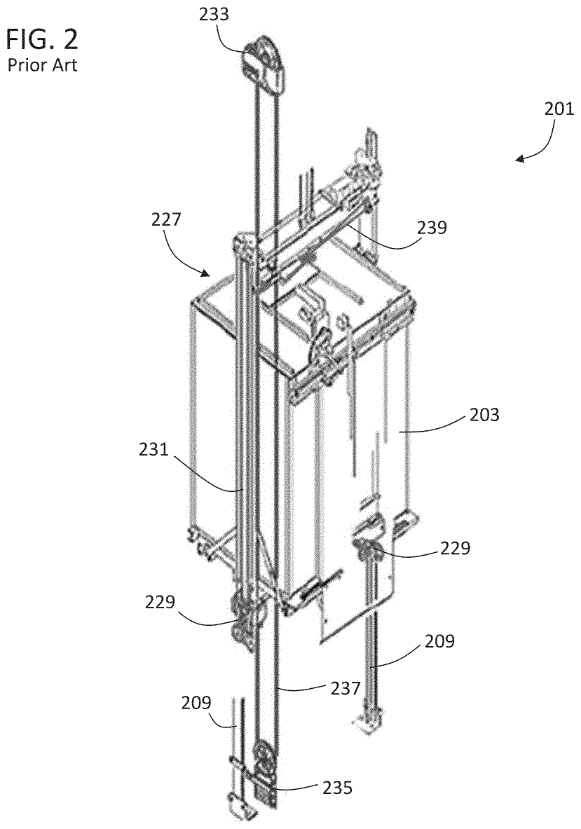

Turning to FIG. 2, a schematic illustration of a prior elevator car overspeed safety system 227 of an elevator system 201 is shown. The elevator system 201 includes an elevator car 203 that is movable within an elevator shaft along guide rails 209. In this illustrative embodiment, the overspeed safety system 227 includes a pair of braking elements 229 that are engageable with the guide rails 209. The braking elements 229 are actuated, in part, by operation of lift rods 231. The triggering of the braking elements 229 is achieved through a governor 233, typically located at the top of the elevator shaft, which includes a tension device 235 located within the pit of the elevator shaft with a cable 237 operably connecting the governor 233 and the tension device 235. When an overspeed event is detected by the governor, the overspeed safety system 227 is triggered, and a linkage 239 is operated to actuate both lift rods 231 simultaneously such that a smooth and even stopping or braking force is applied to stop the travel of the elevator car. The linkage 239, as shown, is located on the top of the elevator car 203. However, in other configurations, the linkage may be located below a platform (or bottom) of the elevator car. As shown, various components are located above and/or below the elevator car 203, and thus pit space and overhead space within the elevator shaft must be provided to permit operation of the elevator system 201.

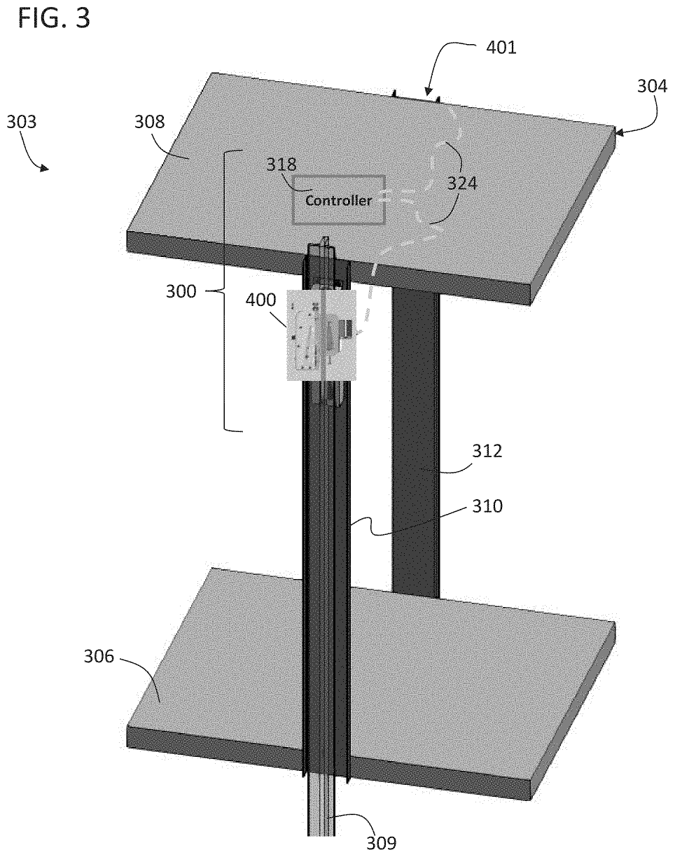

Embodiments described herein are directed to providing electrical elevator overspeed safety systems. Such systems do not require a governor and cable to trigger the elevator safety. FIG. 3 depicts an elevator car 303 having an overspeed safety system 300 in accordance with an embodiment of the present disclosure, An elevator car frame 304 includes the elevator overspeed safety system 300 installed thereto. The car frame 304 includes a platform 306, a ceiling 308, a first structural member 310, and a second structural member 312. The structural members are depicted as part of an elevator car, but may also be employed on the counterweight. The car frame 304 defines a frame for supporting various panels and other components that define the elevator car for passenger or other use (i.e., define a cab of the elevator), although such panels and other components are omitted for clarity of illustration. The elevator car 303 is moveable along guide rails 309, similar to that shown and described above. The overspeed safety system 300 provides a safety braking system that can stop the travel of the elevator car 303 during an overspeed event.

The overspeed safety system 300 includes a first safety 400 and a control system or safety system controller 318 operably connected to the first safety 400. The first safety 400 is arranged along the first structural member 310. A second safety 401 is arranged along the second structural member 312. The safety system controller 318 is also operably connected to the second safety 401. The connection between the safety system controller 318 and the first safety 400 and second safety 401 may be provided by a communication line 324. The communication line 324 may be wired or wireless, or a combination thereof (e.g., for redundancy). As shown, the safety system controller 318 is located on the top or ceiling 308 of the car frame 304. However, such position is not to be limiting, and the safety system controller 318 may be located anywhere within the elevator system (e.g., on or in the elevator car, within a controller room, etc.). The safety system controller 318 may comprise electronics and printed circuit boards for processing (e.g., processor, memory, communication elements, electrical buss, etc.). Thus, the safety system controller 318 may have a very low profile and may be installed within ceiling panels, wall panels, or even within a car operating panel of the elevator car 303.

The overspeed safety system 300 is an electromechanical system that eliminates the need for a linkage or linking element installed at the top or bottom of the elevator car. The safety system controller 318 may include, for example, a printed circuit board with multiple inputs and outputs. In some embodiments, the safety system controller 318 may include circuitry for a system for control, protection, and/or monitoring based on one or more programmable electronic devices (e.g., power supplies, sensors, and other input devices, data highways and other communication paths, and actuators and other output devices, etc.). The safety system controller 318 may further include various components to enable control in the event of a power outage (e.g., capacitor/battery, etc.). The safety system controller 318 may also include an accelerometer and/or absolute position reference system to determine a speed of an elevator car. In such embodiments, the safety system controller 318 is mounted to the elevator car, as shown in the illustrative embodiments herein.

The safety system controller 318, in some embodiments, may be connected to and/or in communication with a car positioning system, an accelerometer mounted to the car (i.e., a second or separate accelerometer), and/or to the elevator controller. Accordingly, the safety system controller 318 may obtain movement information (e.g., speed, direction, acceleration) related to movement of the elevator car along an elevator shaft. The safety system controller 318 may operate independently of other systems, other than potentially receiving movement information, to provide a safety feature to prevent overspeed events. The safety system controller 318 may also be tied to a safety chain of the elevator system that initiates safety measures such as stopping the elevator machine 111, applying a machine brake, etc.

The safety system controller 318 may process the movement information provided by a car positioning system to determine if an elevator car is over speeding beyond a certain threshold or accelerating beyond a threshold. If the threshold is exceeded, the safety system controller 318 will trigger the first safety 400 and the second safety 401 to stop the elevator car. The safety system controller 318 will also provide feedback to the elevator control system about the status of the overspeed safety system 300 (e.g., normal operational position/triggered position).

Although FIG. 3 is illustratively shown with respect to an elevator car, the configuration of the overspeed safety system may be similar to any traveling component (e.g., counterweight). The overspeed safety system 300 of the present disclosure enables electrical and electromechanical safety braking in the event of overspeed, overacceleration, free fall events, safety chain breaks, etc. (hereinafter “triggering events”). The electrical aspects of the present disclosure enable the elimination of the physical/mechanical linkages that have traditionally been employed in overspeed safety systems. That is, the electrical connections allow for simultaneous triggering of two separate safety brakes through electrical signals, rather than relying upon mechanical connections.

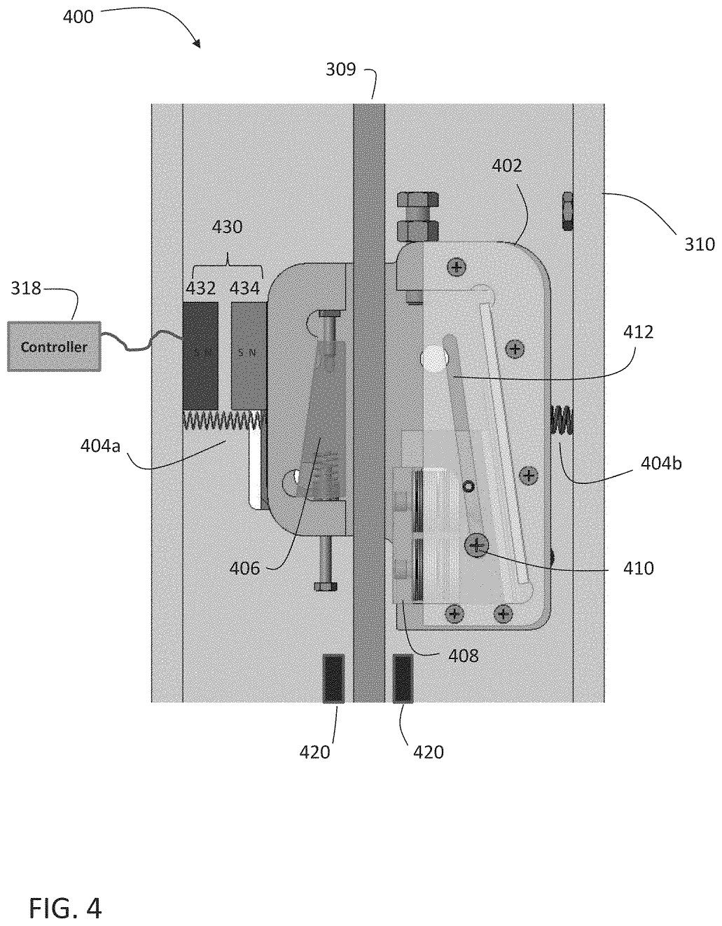

FIG. 4 depicts the first safety 400 in an example embodiment. The second safety 401 may be constructed in a similar manner. The safety 400 includes a safety block 402 on which elements of the safety 400 are mounted. The safety block 402 is held in a centered position about guiderail 309 by at least one biasing member 404a and 404b. The biasing members 404a and 404b may be implemented using springs having one end affixed to the first structural member 310 and a second end affixed to the safety block 402. It is understood that the biasing members 404 may be implemented using other components, such as hydraulic pistons, magnetic components, etc.

Biasing member 404b moves the safety back 402 into its original position after actuation, as described in further detail herein. Biasing member 404a holds the safety block 402 in a first state, e.g., normal running position. It is understood that FIG. 4 depicts an example embodiment, and a single biasing member may be used to achieve the same functions.

A first brake element 406 is positioned on the safety block 402 on a first side of the guide rail 309. The first brake element 406 may be stationary with respect to the safety block 402. A second brake element 408 is positioned on the safety block 402 on a second side of the guide rail 309, opposite the first brake element 406. The second brake element 408 may be a moveable brake element. A mount of the second brake element 408 includes a pin 410 that travels with a slot 412. Slot 412 is angle towards the guide rail 309, such that when the second brake element 408 moves upwards in the safety block 402, the second brake element 408 also moves towards the guide rail 309. It is noted that the location of first brake element 406 and the second brake element 408 may be reversed with respect to the guide rail 309 depending on the specification arrangement of the safety 400. As shown in FIG. 4, the safety 400 is asymmetrical, meaning the first brake element 406 is fixed and the second brake element 408 moves. Other embodiments may utilize a symmetrical safety in which both the first brake element 406 and the second brake element 408 move.

An actuator 430 is controlled by the controller 318. The actuator 430 applies a force to the safety block 402 to translate the safety block 402 in a direction perpendicular to a longitudinal axis of the guide rail 309. In the embodiment if FIG. 4, the actuator 430 includes an electromagnet 432 mounted to the first structural member 310 and a permanent magnet 434 mounted to the safety block 402. It is understood that the electromagnet 432 and the permanent magnet 434 may be mounted in locations other than those shown in FIG. 4.

FIG. 4 depicts the safety 400 in a first state, in which normal operation of the traveling component (car/counterweight) is possible. The biasing members 404 keep the safety block 402 in a position such that the first brake element 406 and the second brake element 408 do not contact the guide rail 309. A pair of guides 420 may be mounted to the first structural member 310. The guides 420 may also be mounted on roller guides that travel along the guide rail 309. The guides 420 are positioned to straddle the guide rail 309. The guides 420 aid in centering the safety block 402 about the guide rail 309 to prevent false actuation of the safety 400.

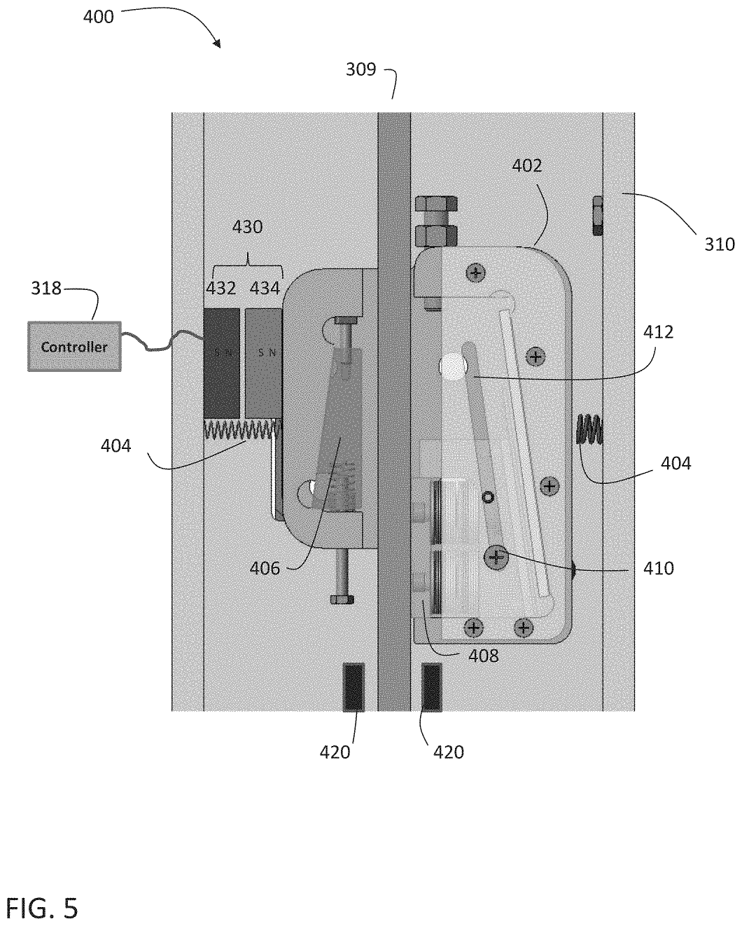

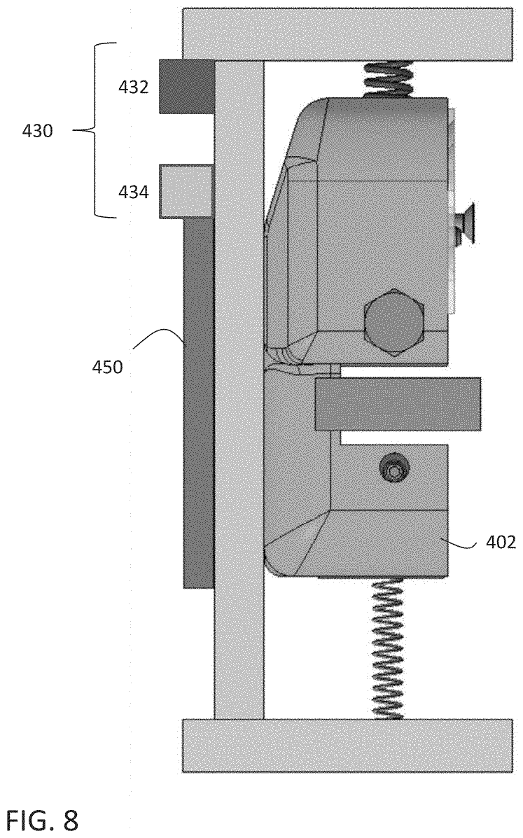

Operation of the safety 400 is discussed with reference to FIGS. 5-7. If a triggering event is detected, controller 318 sends an activation signal to the actuator 430. This provides power to the electromagnet 432, which applies a force on the permanent magnet 434. The resultant force overcomes the biasing members 404 and moves the safety block 402 in a first direction, perpendicular to a longitudinal axis of the guide rail 309, such that second brake element 408 contacts guide rail 309. The safety block 402 is able to translate perpendicular to a longitudinal axis of the guide rail 309 as a mounting plate floats in an opening in the first structural member 310, as described herein with reference to FIGS. 8-10. The second state depicted in FIG. 5 may be referred to as an armed state.

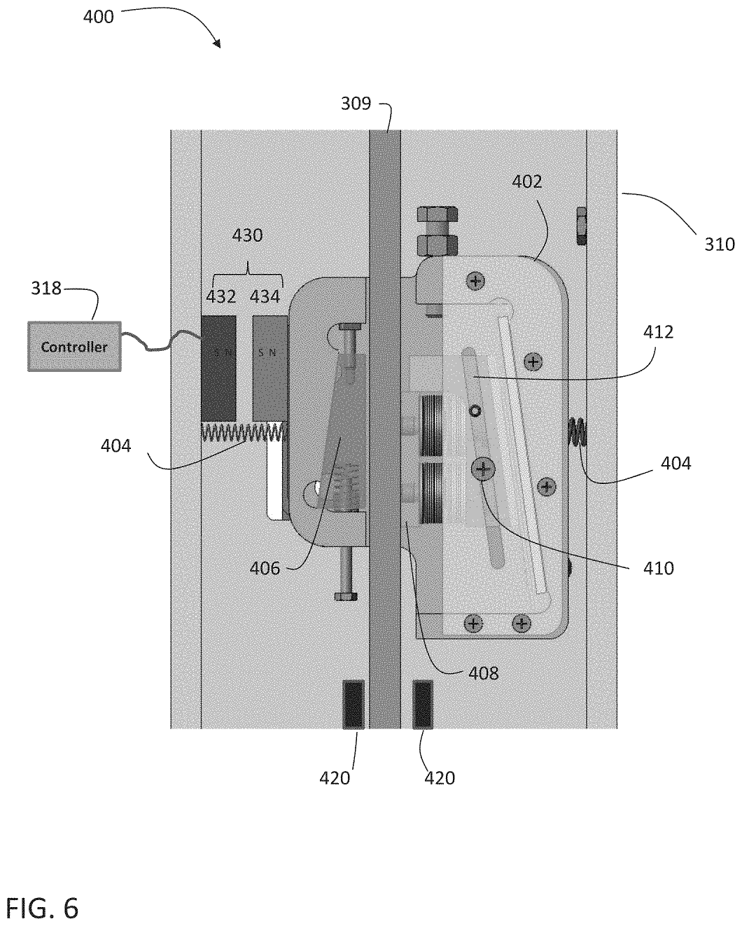

If the traveling component (car or counterweight) moves downwards relative to the position shown in FIG. 5, the safety block 402 moves downwards, as shown in FIG. 6. As the moving brake element 408 is fixed against the guide rail 309, the safety block 402 translates in a second direction, perpendicular to a longitudinal axis of the guide rail 309, and opposite the first direction due to the angled slot 412 and pin 410. As shown in FIG. 6, the safety block 402 has moved to the right, moving the first brake element 406 closer to the guide rail 309.

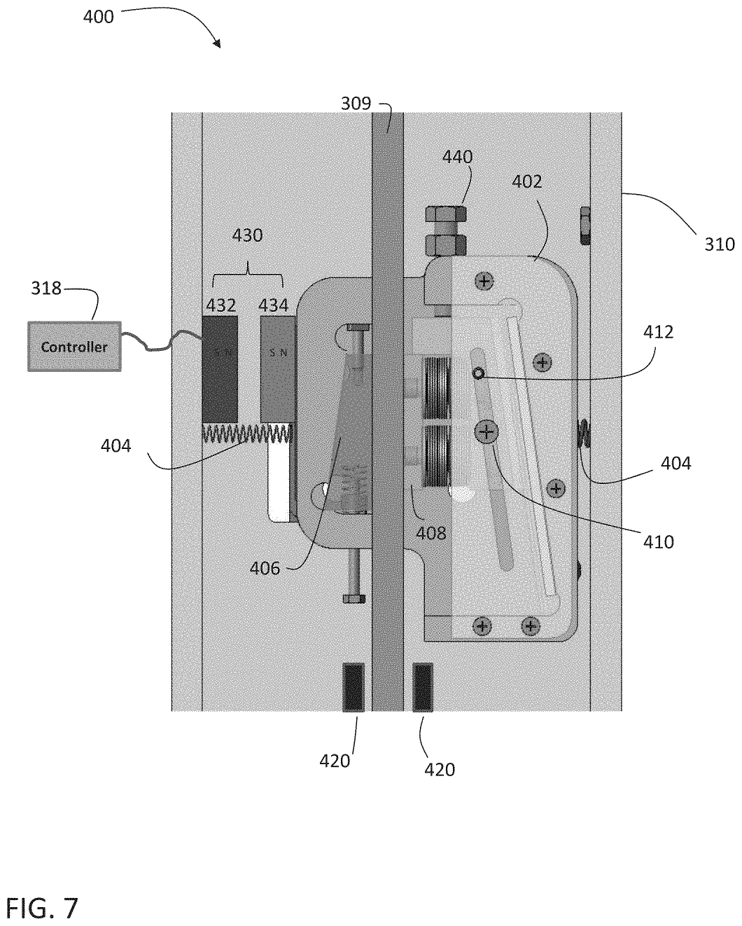

As the traveling component (car or counterweight) continues to move downwards relative to the position shown in FIG. 6, the safety block 402 moves downwards, as shown in FIG. 7. The safety block translates in the second direction, perpendicular to a longitudinal axis of the guide rail 309, and opposite the first direction due to the angled slot 412 and pin 410. Travel of the second brake element 408 is limited by an adjustable stop 440 in the safety block 402. In this state, the first brake element 406 is in contact with guide rail 309 along with the second brake element 408 to prevent further movement of the traveling component. The third state may be referred to as a braking state.

The safety 400 may be reset to the first state of FIG. 4 when the traveling component moves upwards, relative to the position shown in FIG. 7. This causes the moving brake element 408 to drop to the bottom of the safety block 402. The biasing members 404 force the safety block 402 into the first state in which neither first brake element 406 nor second brake element 408 is in contact with the guide rail 309.

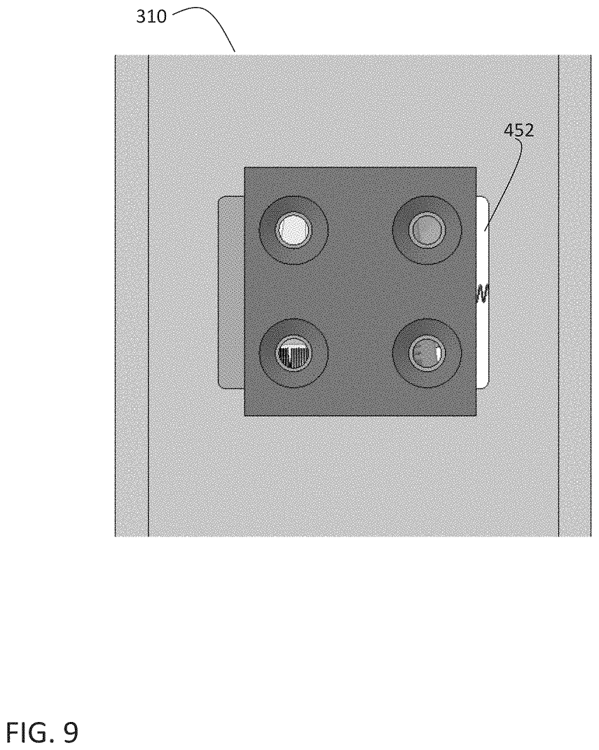

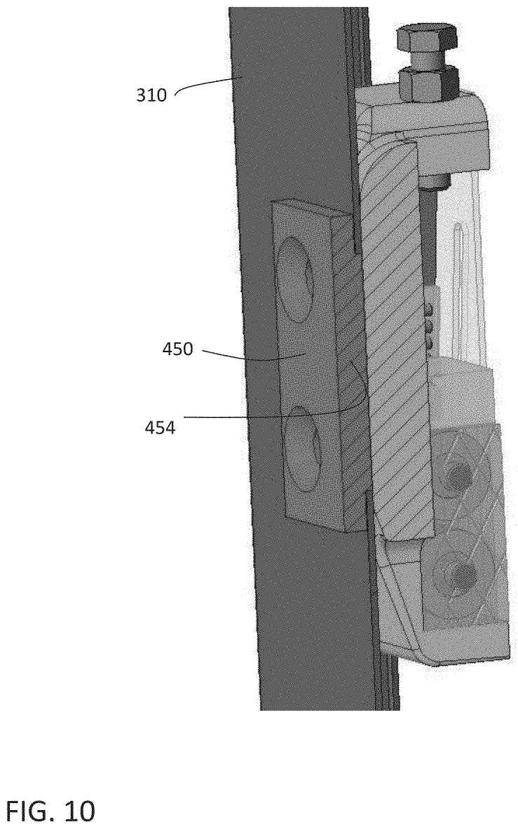

As noted above, the safety block 402 translates in a first direction perpendicular to the guide rail 309 and a second direction perpendicular to the guide rail 309, the second direction opposite the first direction. FIG. 8 depicts a mounting plate 450 that is secured to the safety block 402. As shown in FIG. 9, an opening is provided in the first structural member 310 that allows the mounting plate 450, and thus the safety block 402, to translate relative to the first structural member 310. As shown in FIG. 10, the mounting plate 450 includes a tongue 454 that travels within the opening 452.

Referring back to FIG. 8, the actuator 430 may be located on the rear side of the first structural member 310, rather than on the front side. The electromagnet 432 is mounted to the first structural member 310 and the permanent magnet 434 is mounted to the mounting plate 450. It is understood that other mounting arrangements and actuator components may be used in alternate embodiments.

In the example embodiments of FIGS. 4-7, the actuator 430 is unpowered until a trigger event (e.g., overspeed, break in safety chain, etc.) and providing power to the actuator 430 initiates braking. In other embodiments, the actuator 430 is powered in the first state (e.g., normal operation) and the actuator maintains the braking elements 406 and 408 from contacting the guide rail 309. When a trigger event occurs, power is removed from the actuator 430 and at least one of the biasing members 404a and 404b places the braking elements 406 and 408 in contact with the guide rail 309.

Although shown and described herein with respect to overspeed safety systems connected to traveling components, such description is not to be limited. For example, the above described systems and processes may be applied equally to counterweights of elevator systems. In such embodiments, the counterweight overspeed safety systems may be configured to prevent a traveling component from traveling upward or accelerating upward too rapidly and/or to prevent free fall and damage caused by a counterweight overspeed or overacceleration event.

The terminology used herein is for the purpose of describing particular embodiments only and is not intended to be limiting of the present disclosure. The term “about” is intended to include the degree of error associated with measurement of the particular quantity and/or manufacturing tolerances based upon the equipment available at the time of filing the application. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An elevator system comprising:
a traveling component movable along a guide rail within an elevator hoistway, the traveling component including a structural member;
a safety block mounted to the structural member, the safety block translatable in a first direction and a second direction, the safety block including a first brake element and a second brake element;
a biasing member configured to position the safety block in a first position corresponding to a first state in which neither the first brake element nor the second brake element is in contact with the guide rail;
an actuator configured to translate the safety block in the first direction.

2. The elevator system of claim 1, wherein the traveling component is one of an elevator car and a counterweight.

3. The elevator system of claim 1, wherein the biasing member comprises a spring.

4. The elevator system of claim 3, wherein the biasing member comprises a first spring attached at a first side of the safety block and a second spring attached at a second side of the safety block.

5. The elevator system of claim 3, wherein the biasing member comprises a first magnet at a first side of the safety block and a second magnet attached at a second side of the safety block.

6. The elevator system of claim 1, wherein the actuator comprises an electromagnet and a permanent magnet.

7. The elevator system of claim 6, wherein the electromagnet is mounted to the structural member and the permanent magnet is mounted to the safety block.

8. The elevator system of claim 1, wherein the first brake element comprises a stationary brake element.

9. The elevator system of claim 1, wherein the second brake element comprises a moving brake element.

10. The elevator system of claim 1, wherein the safety block is mounted to the structural member by a mounting plate.

11. The elevator system of claim 10, wherein the structural member includes an opening, the mounting plate configured to travel within the opening.

12. The elevator system of claim 1, wherein the first direction is perpendicular to a longitudinal axis of the guide rail.

13. The elevator system of claim 12, wherein the second direction is perpendicular to the longitudinal axis of the guide rail.

14. The elevator system of claim 13, wherein the first direction is opposite the second direction.

15. The elevator system of claim 1, wherein the actuator is powered off when the first brake element and the second brake element are not in contact with the guide rail.

16. The elevator system of claim 15, wherein the actuator is powered on to bring the first brake element and the second brake element into contact with the guide rail.

17. The elevator system of claim 1, wherein the actuator is powered on when the first brake element and the second brake element are not in contact with the guide rail.

18. The elevator system of claim 17, wherein the actuator is powered of to bring the first brake element and the second brake element into contact with the guide rail.

19. The elevator system of claim 1, wherein the first brake element is fixed and the second brake element moves.

20. The elevator system of claim 1, wherein the first brake element and the second brake element move.
